(19) United States
(12) Patent Application Publication
(10) Pub. No.: US 2026/0094224 A1
(43) Pub. Date: Apr. 2, 2026

(54) Workforce Innovation Online Career Exploration and Development Platform for Students and Young Adults

(71) Applicant: StrategyServ LLC, Upper Marlboro, MD (US)

(72) Inventor: Elisa Basnight, Upper Marlboro, MD (US)

(21) Appl. No.: 19/348,653

(22) Filed: Oct. 2, 2025

Related U.S. Application Data
(60) Provisional application No. 63/702,503, filed on Oct. 2, 2024.

(51) Int. Cl. G06Q 50/20; G06Q 30/0207

(52) U.S. Cl. CPC G06Q 50/2057; G06Q 30/0209

(57) ABSTRACT

The present invention relates to a cloud-based workforce development and readiness platform supporting career exploration, workforce development, skills enhancement, and personal growth for students and young adults using a gamified learning approach. The platform comprises a dual SaaS/WaaS™ architecture, including a Software-as-a-Service (SaaS) module for learners and a Workforce-as-a-Service (WaaS™) module for employers, educators, and partners, enabling bidirectional data flows across the ecosystem. The platform further includes a modular AI-powered assistant (GT3S), implemented as a knowledge-based large language model trained on accredited and proprietary workforce data sources, configured to provide personalized guidance, mentor-matching signals, curriculum alignment, and predictive workforce analytics. Users engage with structured programs based on four developmental pillars, earning points and incentives tied to workforce readiness outcomes, including certifications, internships, and employer-aligned skills benchmarks. The system also provides multi-stakeholder dashboards for learners, mentors, educators, and employers, integrating customer relationship management, learning management, e-commerce, donation management, and recruitment functions on a secure cloud infrastructure to create a comprehensive ecosystem for workforce pipeline development.

The current application claims a priority to the U.S. Provisional Patent application Ser. No. 63/702,503 filed on Oct. 2, 2024.

### FIELD OF THE INVENTION

The present invention relates generally to career exploration and development for students and young adults. More specifically, the present invention is an online platform supporting career exploration, workforce development, skills enhancement, and personal growth using a gamified learning approach.

### BACKGROUND OF THE INVENTION

There exists a need for skilled labor in the fields of science, technology, engineering, and mathematics, commonly referred to as STEM, along with supply chain and skilled trades. Collectively, STEM, supply chain, and skilled trades will be referred to as 3S or the 3S Workforce. It is estimated that by 2030, the U.S. could face a shortage of 2 million workers in manufacturing and supply chain alone. Today, we see for every five leaving, only two are coming in to replace those recent departures in the skilled trades. There is significant growth in these industries causing a surge of hiring, but the number of new positions is outpacing the labor pool. There is therefore a need to train and develop experienced people to work in these industries.

The present invention began as a platform for girls specifically, as women have historically been underrepresented in the 3S Workforce. With the skilled labor shortage, the present invention has expanded to include all students and young adults to provide the necessary tools to enter the 3S Workforce.

### SUMMARY OF THE INVENTION

The present invention is an online platform for students and young adults which provides them with the necessary tools to develop skills, make connections, and prepare them to enter the 3S Workforce. The platform does so using a gamified approach across a variety of online platforms, including desktops, tablets, and mobile devices.

### BRIEF DESCRIPTION OF THE DRAWINGS

FIG. 1 is a diagram of the platform of the present invention.

FIG. 2 is a block diagram of an exemplary embodiment of the present invention.

FIG. 3 shows the pipeline process of the present invention.

FIG. 4 is a registration page of the present invention.

FIG. 5 is a member hub of the present invention.

FIG. 6 shows the four pillars and brand communities of the present invention.

FIG. 7 is a start page of the gamification of the present invention.

FIG. 8 is a sequence diagram of a learner-initiated workflow of the present invention.

FIG. 9 is an example of the gamification of the present invention.

FIG. 10 is an example of a points system of the present invention.

FIG. 11 is a learning dashboard of the present invention.

FIG. 12 is a learning hub of the present invention.

FIG. 13 is a course progress page of the present invention.

FIG. 14 is an external activities management page of the present invention.

FIG. 15 is a course progress page of the present invention.

FIG. 16 shows an example of a points tracker of the present invention.

FIG. 17 is an overview of the present invention

FIG. 18 is an employer-initiated workflow of the present invention.

FIG. 19 is a partner hub orientation page of the present invention.

FIG. 20 is a partner dashboard of the present invention.

FIG. 21 is an example of a partner hub data and analytics page of the present invention.

FIG. 22 is a mentor progress report of the present invention.

FIG. 23 is an educator alignment workflow of the present invention.

FIG. 24 is a group leader orientation page of the present invention.

FIG. 25 is a group leader course and member report page of the present invention.

FIG. 26 is an add course page of the present invention.

FIG. 27 is an example of learners' analytics of the present invention.

FIG. 28 is an example of a store where users may exchange points or money for rewards.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present disclosure includes many aspects and features. Moreover, while many aspects and features relate to, and are described in the context of an online platform supporting career exploration, workforce development, skills enhancement, and personal growth using a gamified learning approach, embodiments of the present disclosure are not limited to use only in this context.

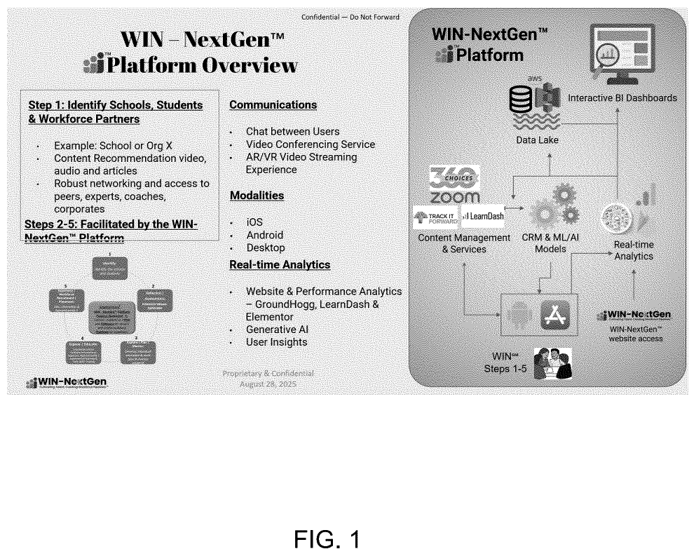

The disclosed invention comprises a dual-architecture platform including (i) a Software-as-a-Service (SaaS) module for learners, and (ii) a Workforce-as-a-Service (WaaS™) module for employers, educators, and partners. These modules are coordinated through a central cloud platform controller that provides authentication, data routing, and orchestration services. FIG. 1 shows an overview of the platform of the present invention.

The platform further comprises a modular AI-powered assistant (GT3S) implemented as a knowledge-based large language model. GT3S is trained on federally accredited datasets, proprietary WIN-NextGen™ data, and partner insights, enabling domain-specific personalization and predictive analytics. GT3S interacts bidirectionally with both SaaS and WaaS™ components, providing a unified intelligence layer across the system.

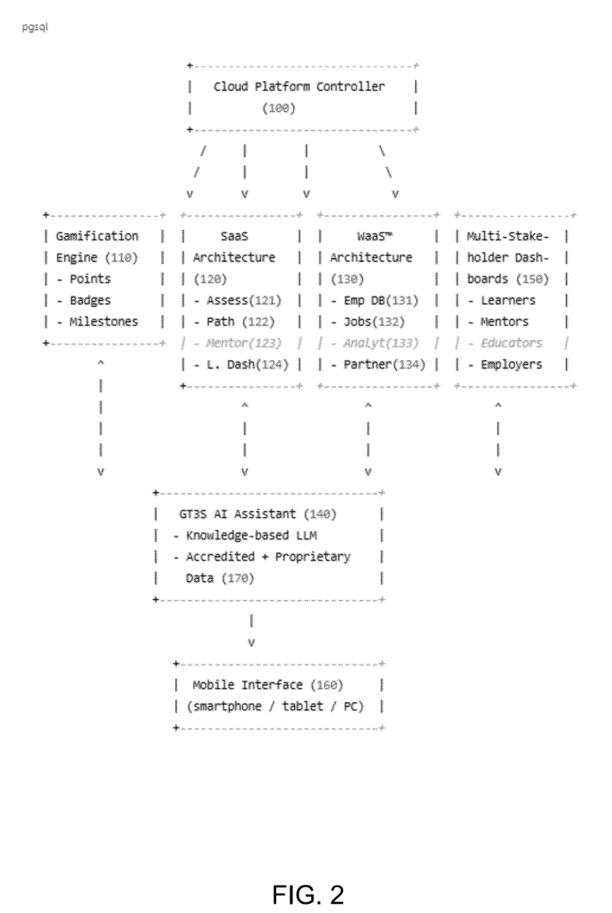

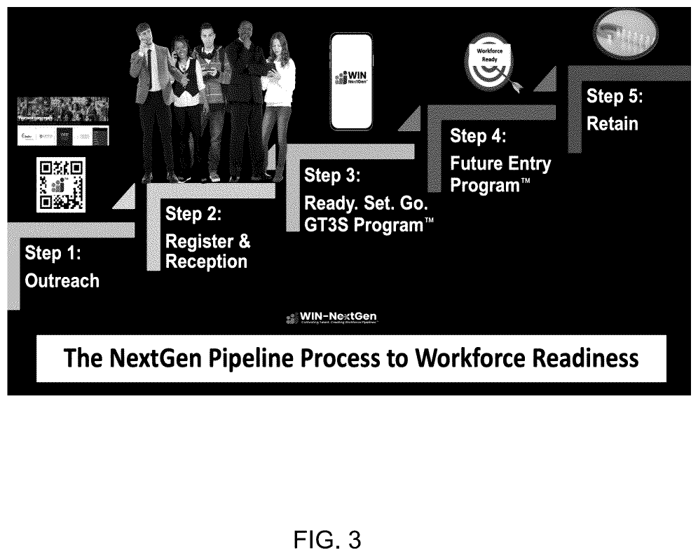

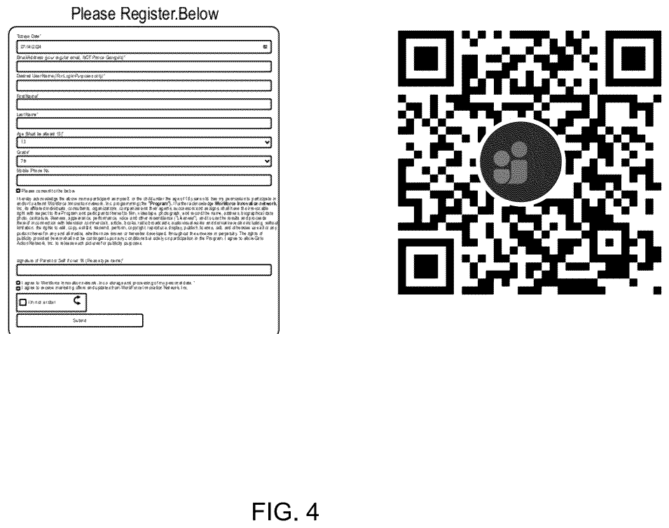

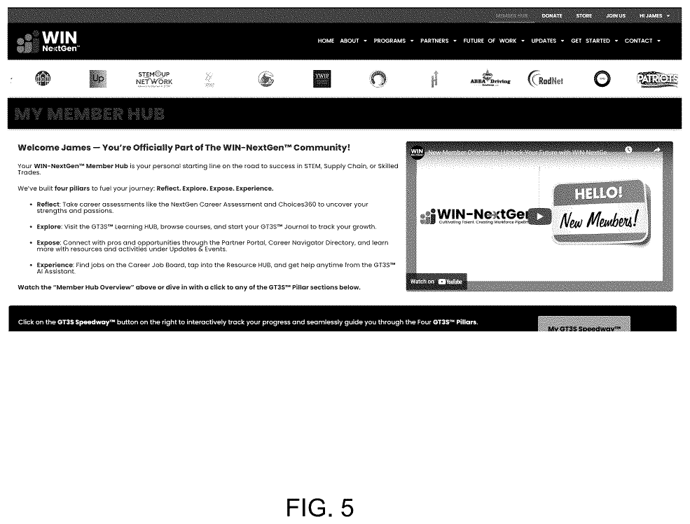

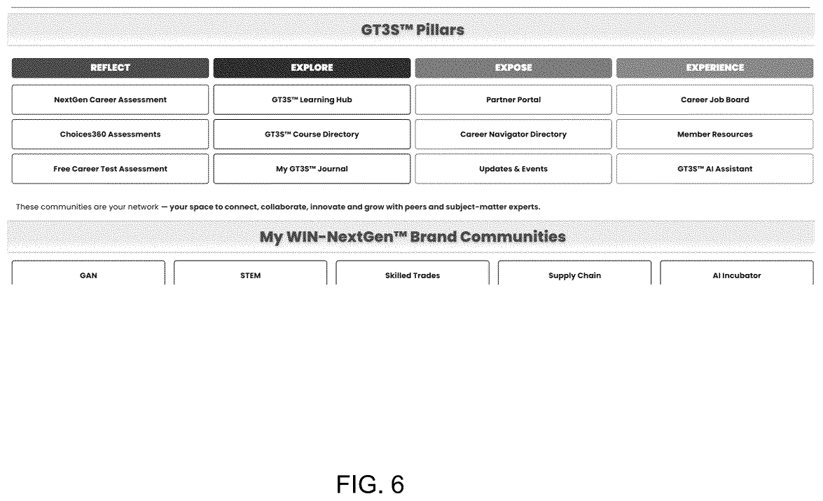

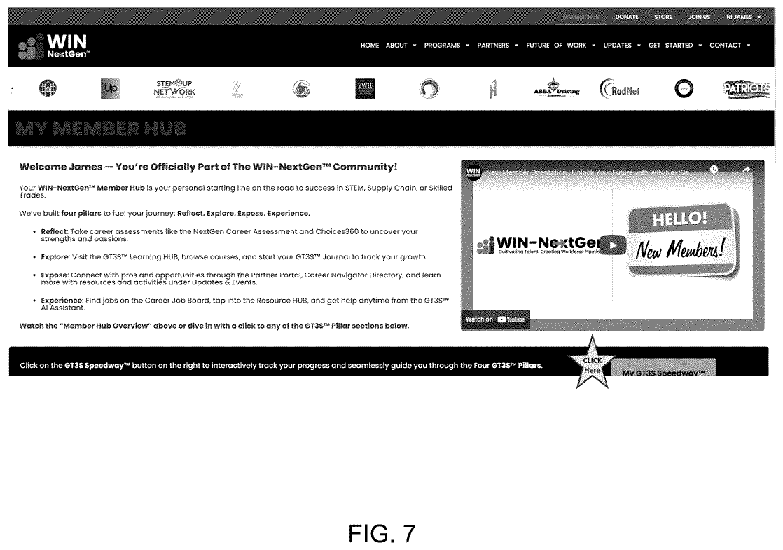

### SaaS Module (Learner-Facing)—FIG. 2

The SaaS module delivers a personalized, gamified experience for students and young adults. Core submodules include:
Career Assessments: intake forms and psychometric tools generating learner profiles.
Guided Pathways: AI-informed learning journeys aligned with workforce demand.
Mentor Matching: pairing algorithms enhanced by GT3S natural language processing.
Learner Dashboards: role-specific dashboards displaying progress, milestones, and career readiness indicators.

Data Flow: When a learner completes an assessment, the SaaS module is able to provide responses to the learner via prompts to GT3S, which retrieves insights from accredited and proprietary data sources. GT3S then generates recommended pathways, skill-building activities, and mentor matches, which are fed back into the learner for action within their Member Hub.

FIG. 2 illustrates a block diagram of an exemplary cloud-based workforce development and readiness platform, including a Software-as-a-Service (SaaS) module for learners, a Workforce-as-a-Service (WaaS™) module for employers and partners, a gamification engine, a modular AI-powered assistant (GT3S), multi-stakeholder dashboards, and mobile interfaces connected via a cloud controller.

### Gamification System

The platform incorporates a gamification system spanning the SaaS experience. Learners earn points, badges, and milestones for completing activities across four developmental pillars: Reflection, Explore, Expose, and Experience. Unlike prior systems, gamified outcomes are directly linked to workforce readiness benchmarks, including completion of certifications, internships, job shadowing, and employer-aligned skill validations.

Data Flow (Gamification↔GT3S): The gamification system exchanges data with GT3S to dynamically adapt challenge difficulty, recommend skill activities, and calibrate readiness scores. Gamification outputs are stored as structured signals, which inform predictive analytics in the WaaS™ module.

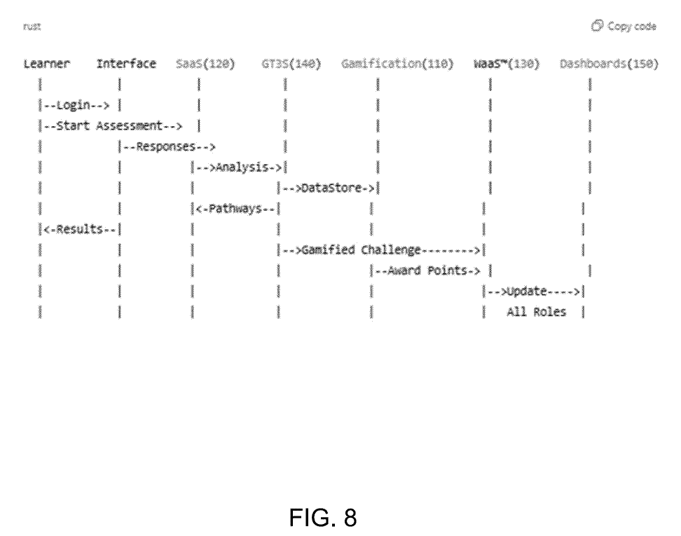

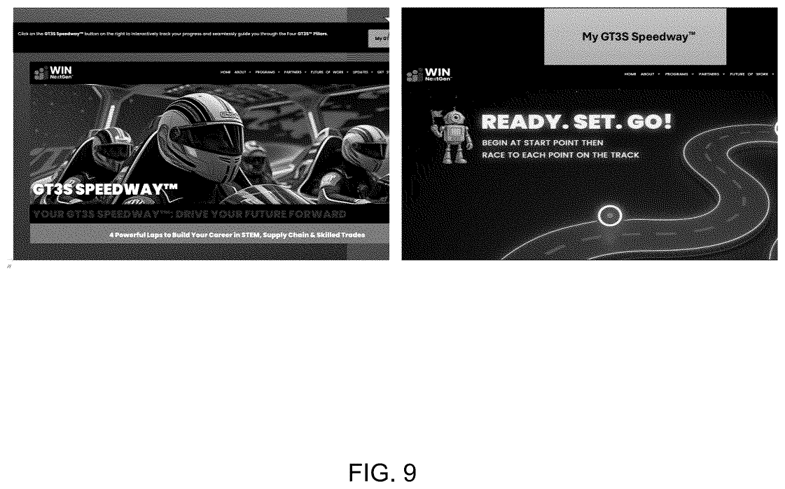

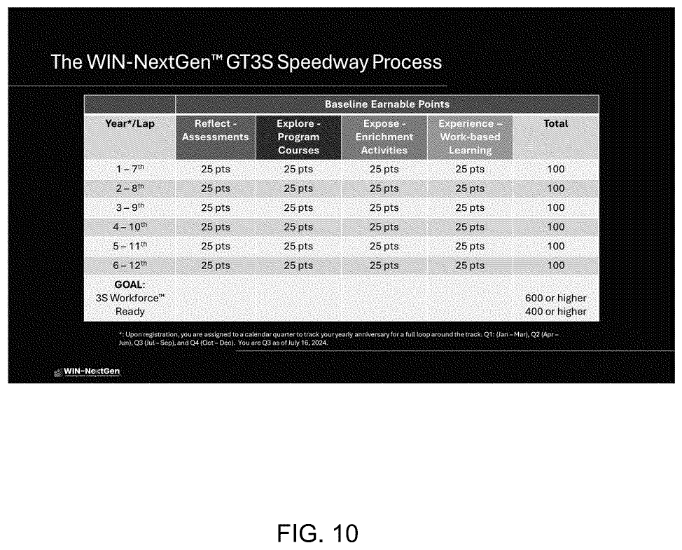

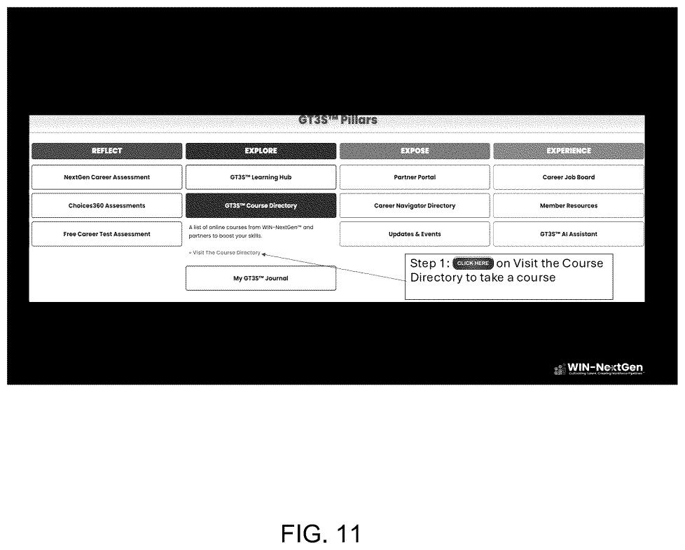

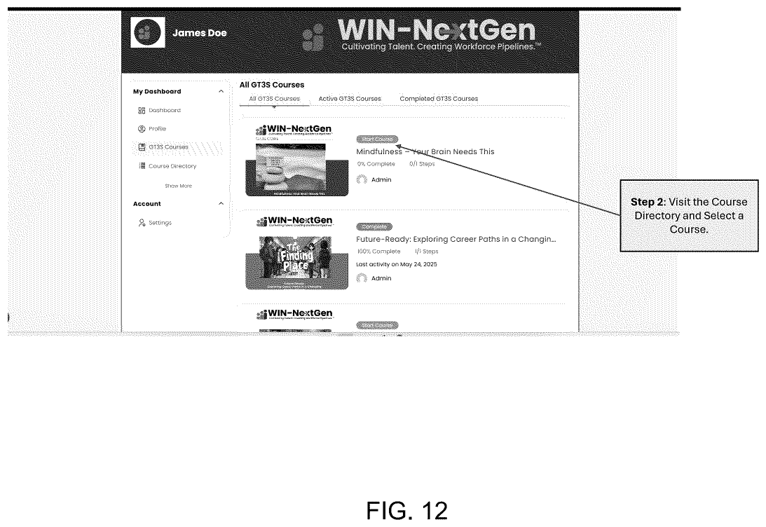

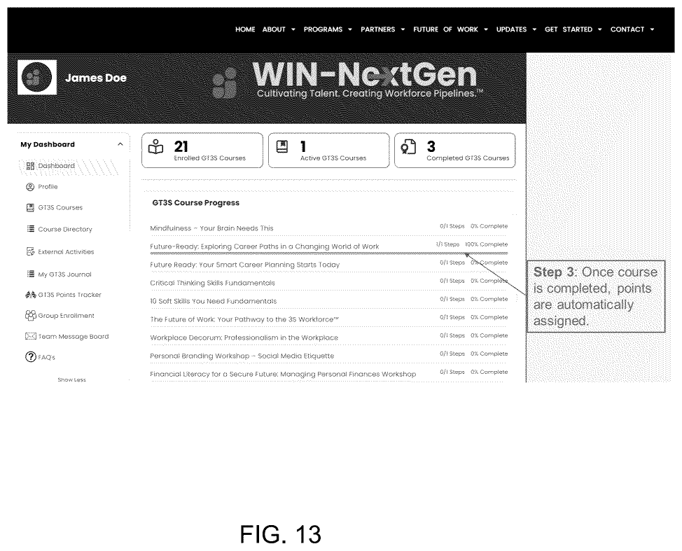

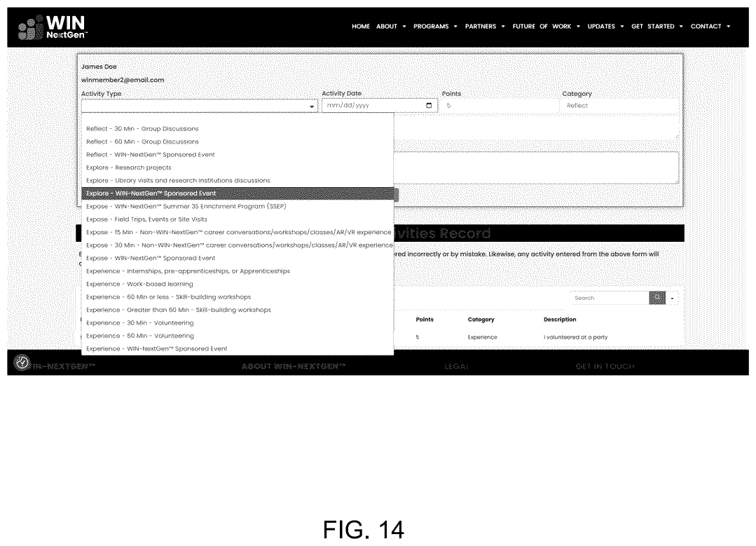

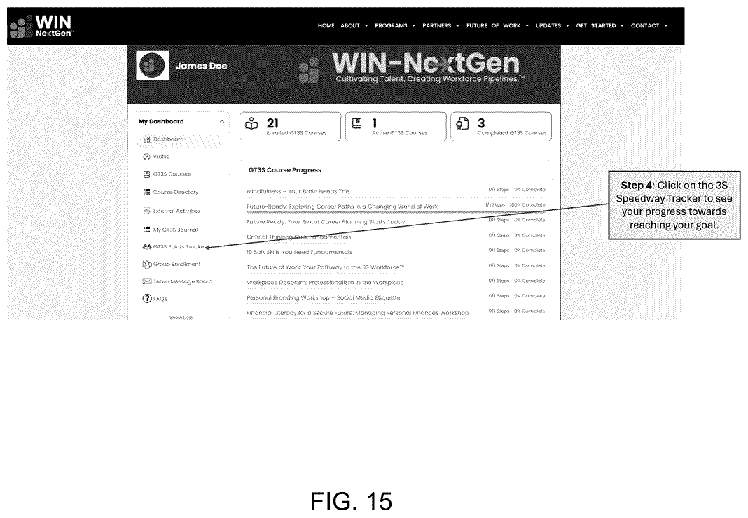

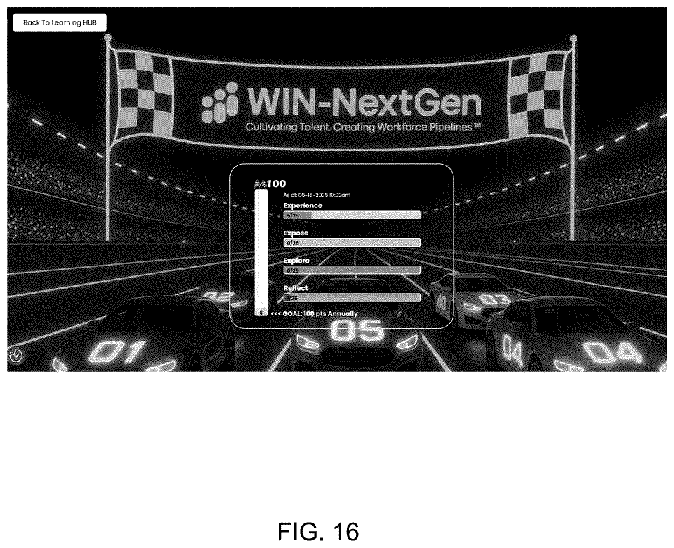

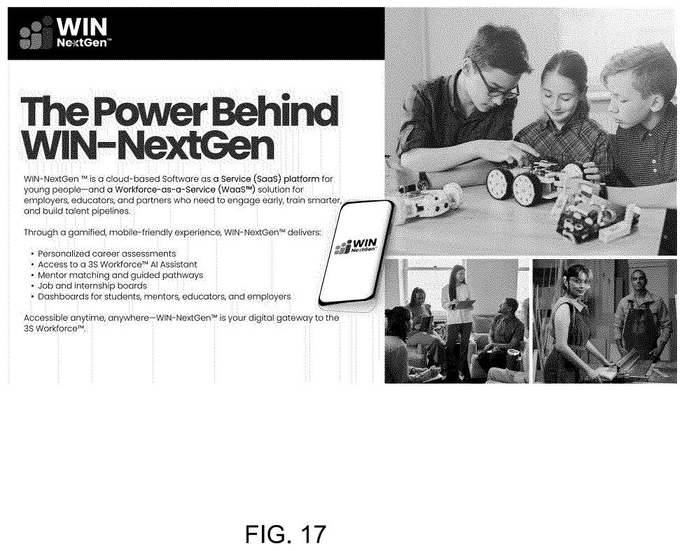

FIG. 8 illustrates a sequence diagram of a learner-initiated workflow, in which a learner completes a career assessment through the SaaS module, the GT3S AI Assistant generates personalized pathways, the gamification engine awards points and milestones, and the WaaS™ module updates employer-side analytics, with outputs displayed across multi-stakeholder dashboards.

### WaaS™ Module (Employer/Educator-Facing)

The WaaS™ module provides employers, educators, and workforce partners with tools to view and manage early talent pipelines. Core submodules include:
Job and Internship Boards: employers post opportunities that are algorithmically matched to learners.
Employer Dashboards: visualizations of candidate readiness, workforce interests and preparedness metrics, and engagement levels.
Workforce Analytics: predictive modeling of talent pipeline strength based on aggregated learner data.
Educator & Partner Interfaces: curriculum alignment tools and volunteer/mentor management.

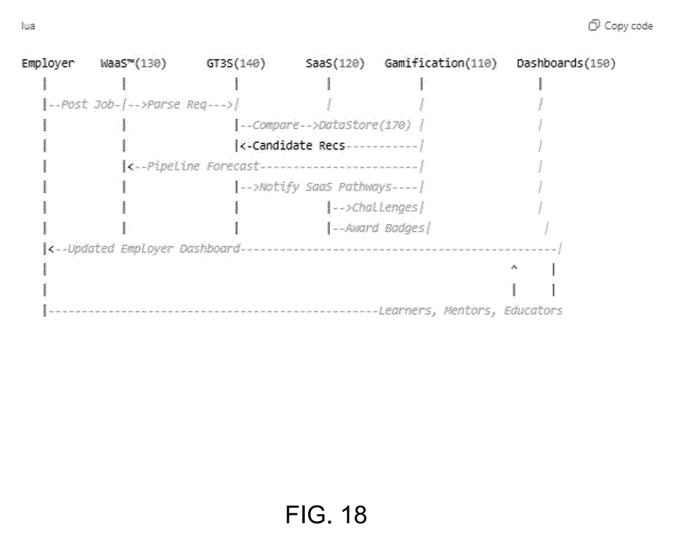

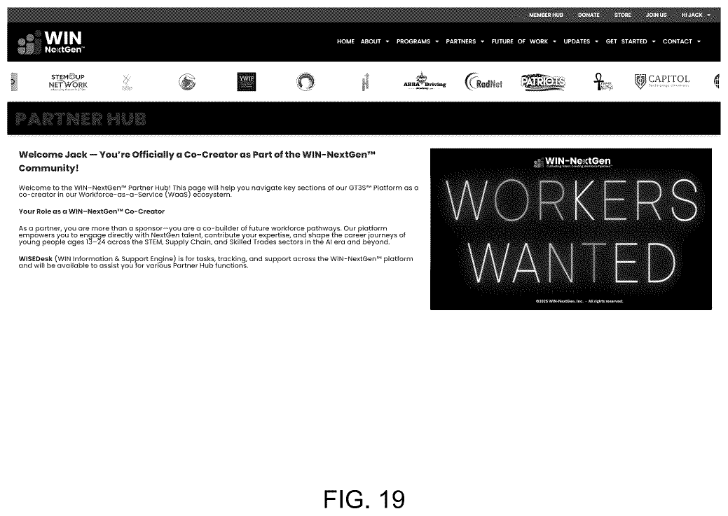

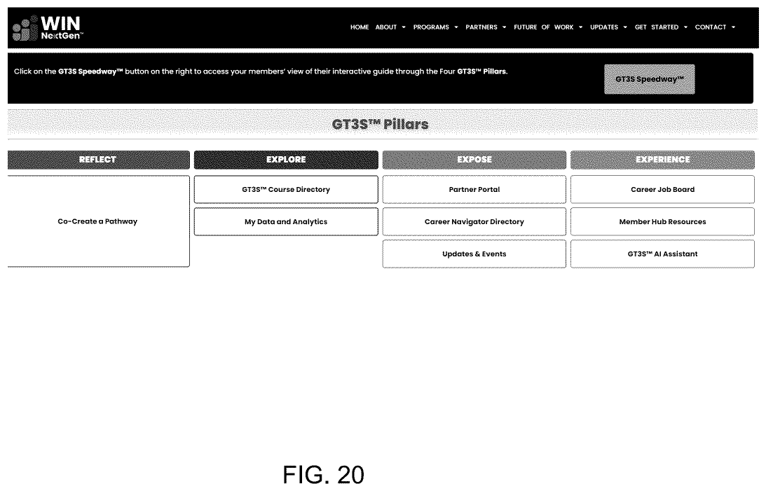

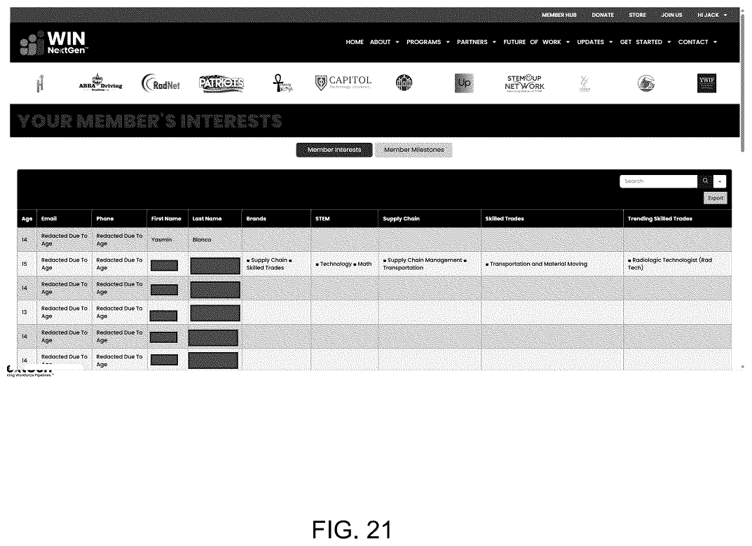

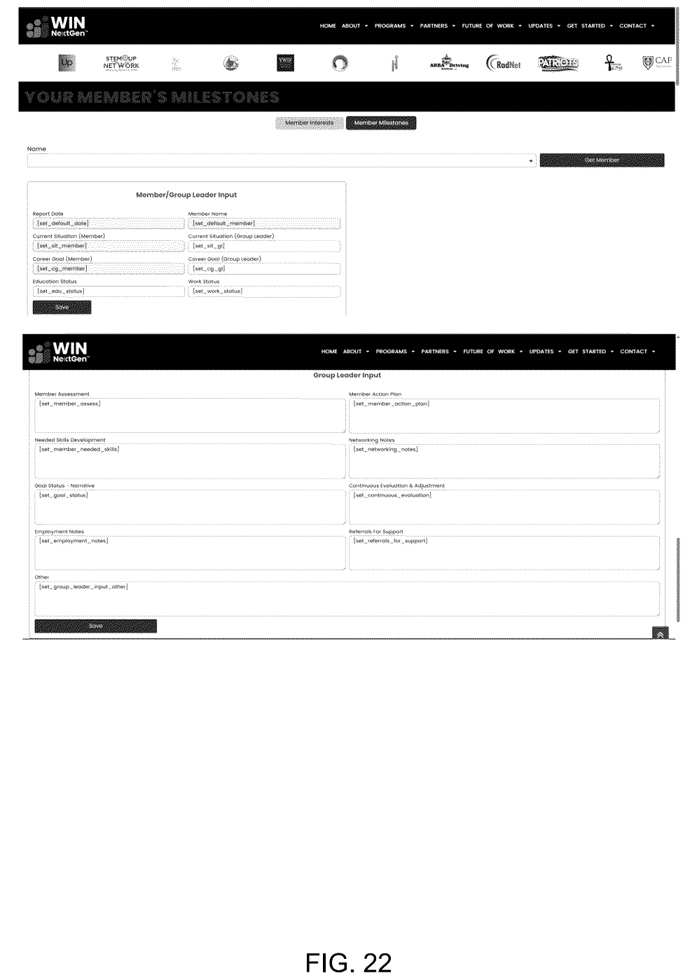

FIG. 18 illustrates an employer-initiated workflow, in which an employer submits a job posting via the WaaS™ module, GT3S analyzes requirements against accredited and proprietary workforce data, candidate recommendations are generated, gamified challenges are triggered for learners, and employer dashboards are updated with predictive pipeline insights.

Data Flow: GT3S ingests labor demand signals from employer postings and workforce analytics, integrates them with learner readiness profiles that opt-in, and produces predictive workforce recommendations. These outputs inform employer dashboards and inform educator alignment with industry needs.

### Multi-Stakeholder Dashboards

The system delivers role-specific dashboards to learners, mentors, educators, and employers. Each dashboard provides real-time updates powered by GT3S:
Learners: progress tracking, skill recommendations, gamified milestones.
Mentors: mentee readiness insights, suggested interventions.
Educators: curriculum-to-workforce alignment cues.
Employers: predictive analytics on candidate pipelines.

FIG. 29 illustrates a mentor support workflow, in which a mentor requests progress updates on a mentee, the SaaS module and GT3S generate readiness insights and intervention recommendations, the gamification engine suggests new challenges, and dashboards update to reflect learner and mentor activities.

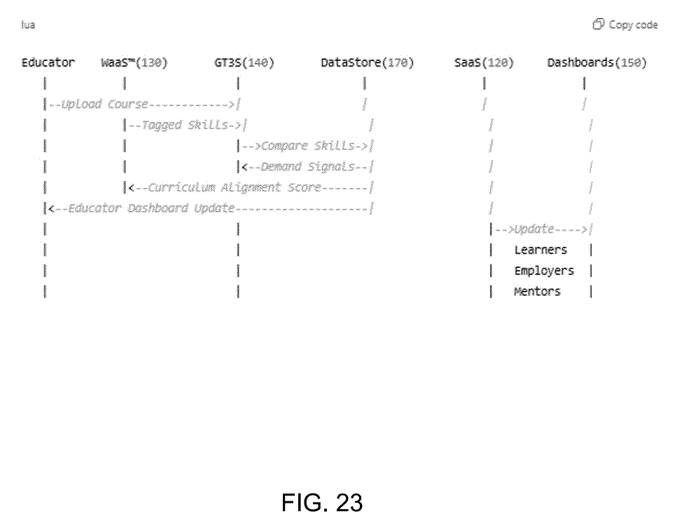

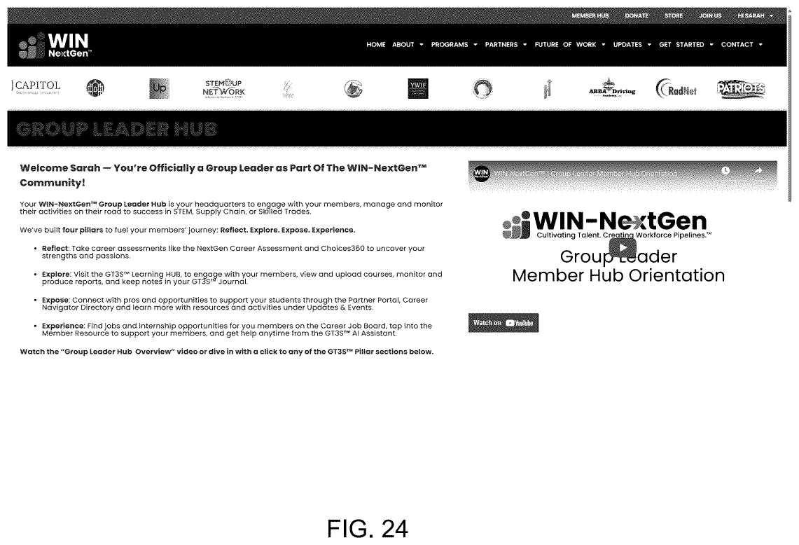

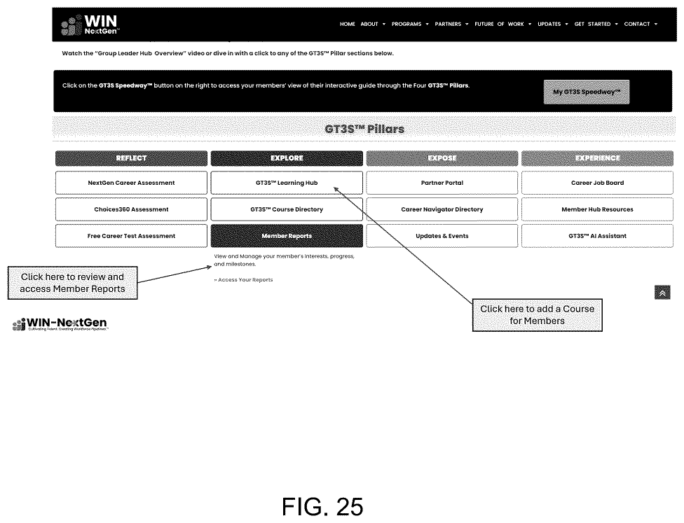

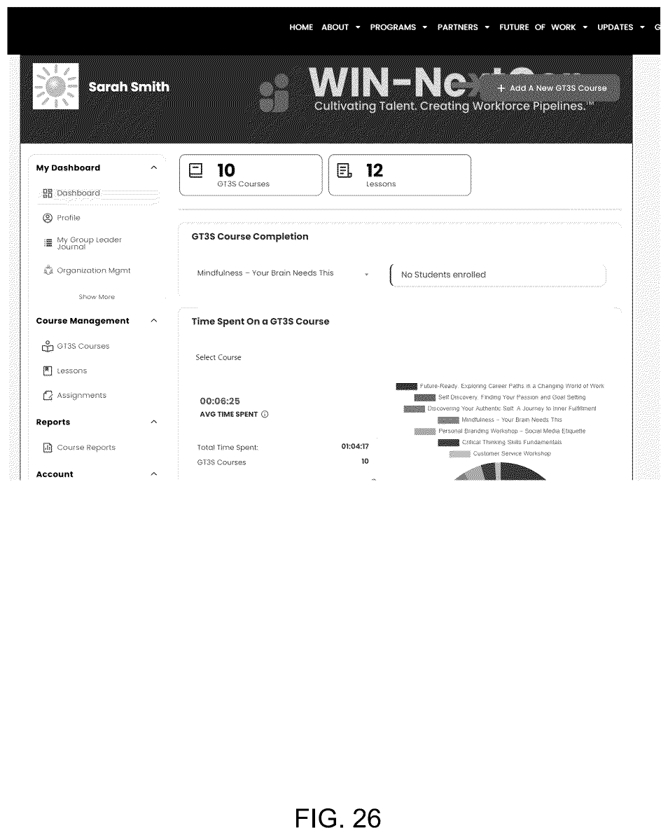

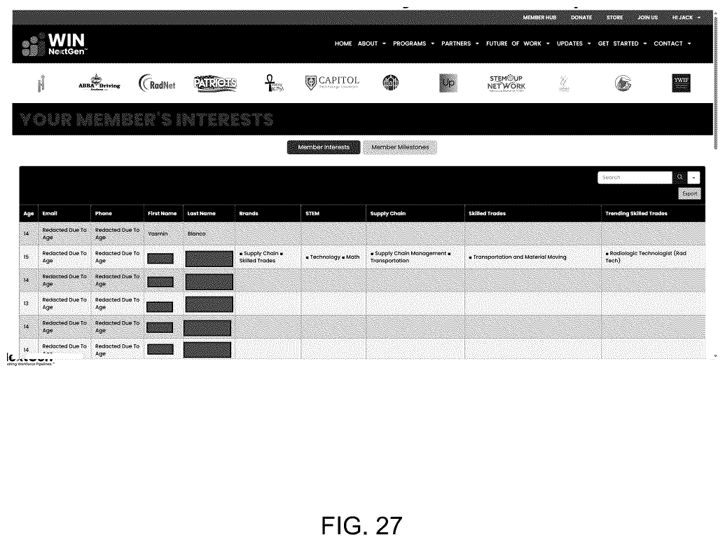

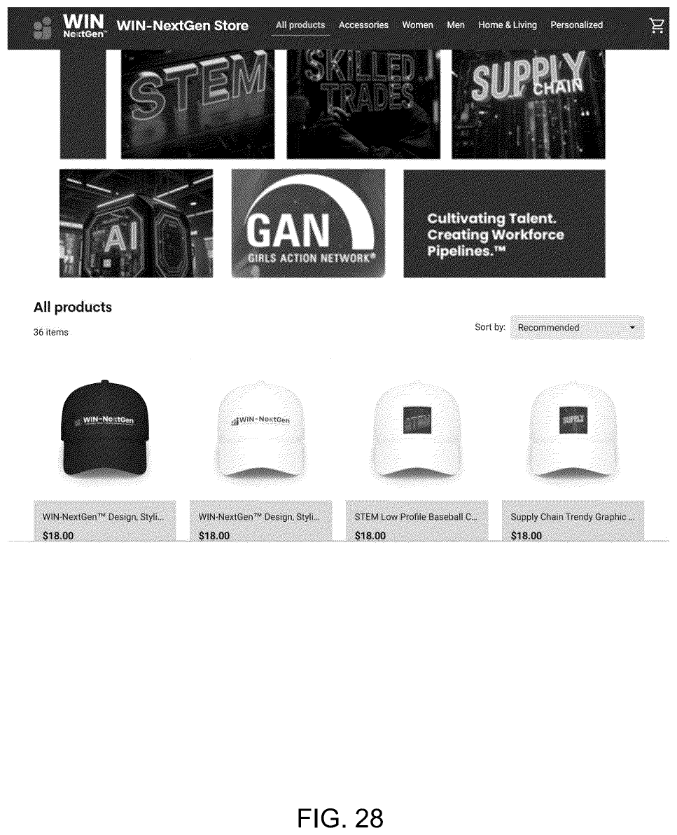

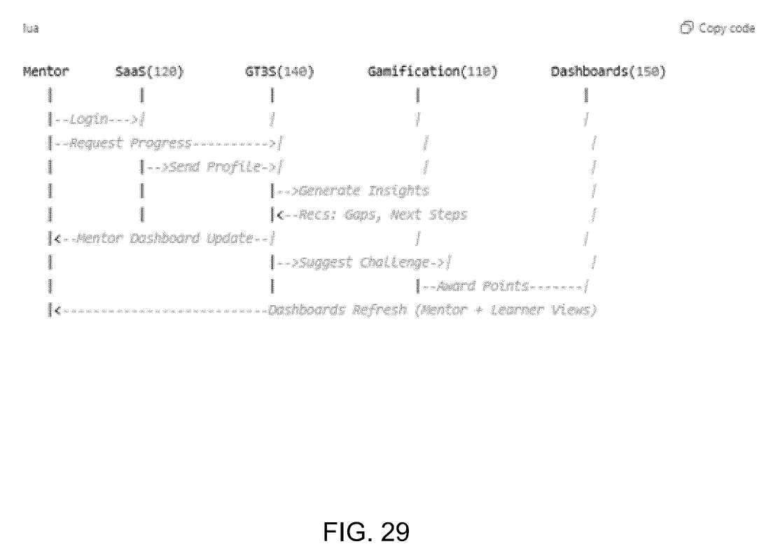

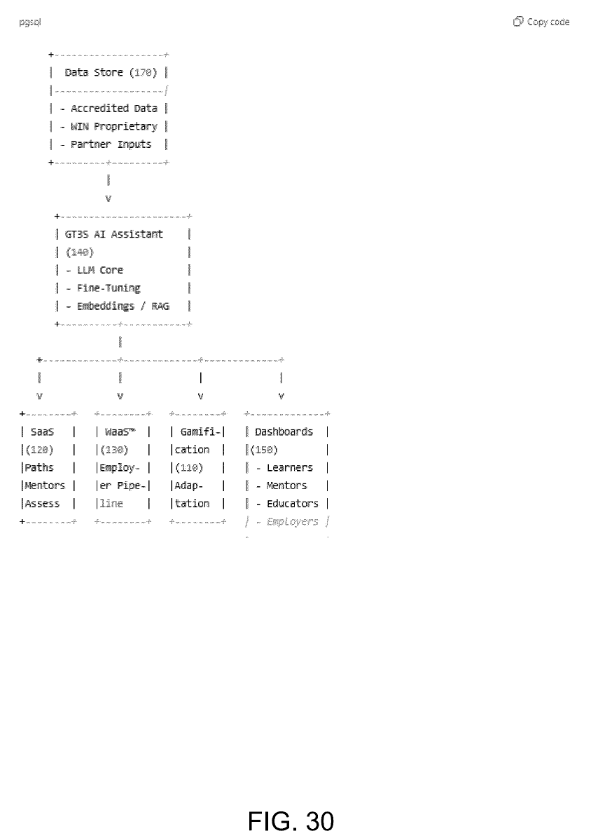

FIG. 23 illustrates an educator alignment workflow, in which an educator uploads a new course or module through the WaaS™ interface, GT3S compares course skills to accredited standards and employer demand signals, a curriculum alignment score is generated, and dashboards update across learners, educators, mentors, and employers.

Data Flow (Dashboards as Aggregators): Dashboards serve as endpoints for integrated data flows, aggregating outputs from SaaS, WaaS™, GT3S, and gamification engines into real-time, user-specific views.

FIG. 30 illustrates a data analytics flow diagram, in which GT3S retrieves multi-source workforce data from accredited datasets, proprietary WIN-NextGen™ datasets, and partner insights, processes the data using large language model techniques, and outputs personalized pathways, predictive analytics, adaptive gamification, and role-specific dashboards.

### End-to-End Method of Operation

1. A learner logs into the SaaS module and completes a career assessment.
2. Assessment data is transmitted to GT3S, which queries the accredited/proprietary knowledge base.
3. GT3S generates personalized pathways and mentor matches, returning them to the learner dashboard.
4. The gamification engine awards points and milestones linked to workforce readiness benchmarks.
5. Employer job postings in WaaS™ are matched against learner pathways; analytics update in real time.
6. Dashboards for learners, mentors, educators, and employers refresh to reflect readiness signals, recommended actions, and pipeline insights.

This closed-loop data cycle produces continuous feedback between learners and workforce stakeholders, ensuring both career readiness for learners and actionable insights for employers.

### Summary of Advantages

The present invention provides numerous advantages over existing systems and methods for education, workforce preparation, and career development. In particular, exemplary embodiments of the disclosed platform provide the following benefits:
Dual-Architecture Design: Integrates a Software-as-a-Service (SaaS) module for learners with a Workforce-as-a-Service (WaaS™) module for employers, educators, and partners, thereby creating a unified system supporting both talent development and workforce demand.
AI-Driven Personalization and Analytics: Incorporates a modular AI-powered assistant (GT3S) implemented as a knowledge-based large language model trained on accredited datasets, proprietary workforce data, and partner insights, providing domain-specific guidance, mentor matching, curriculum alignment, and predictive workforce analytics.
Gamification Linked to Workforce Outcomes: Goes beyond traditional gamification for engagement by tying points, badges, and milestones to tangible workforce readiness benchmarks, such as certifications, internships, job shadowing, and employer-aligned skill validations.
Multi-Stakeholder Dashboards: Delivers real-time, role-specific dashboards for learners, mentors, educators, and employers, enabling simultaneous visibility into progress, readiness signals, curriculum alignment, and workforce pipeline forecasts.
Closed-Loop Data Flows: Provides continuous feedback between learner activities and workforce demand, ensuring that learner pathways are dynamically aligned with evolving labor market needs.
Technical Method Implementation: Unlike generic business methods, the disclosed system employs a technical architecture of cloud-based orchestration, bidirectional data flows, and knowledge-based AI processing to achieve scalable, real-time workforce readiness and analytics.
Ecosystem Integration: Consolidates customer relationship management, learning management, e-commerce, donation management, volunteer coordination, and recruitment functions within a single cloud-based infrastructure, enhancing efficiency and scalability.

These advantages collectively establish the disclosed invention as a novel and non-obvious system and method for workforce development and readiness, providing benefits to multiple stakeholders not taught or suggested by the prior art.

Although the invention has been explained in relation to its preferred embodiment, it is to be understood that many other possible modifications and variations can be made without departing from the spirit and scope of the invention.

What is claimed is:

1. A cloud-based online platform system for career exploration and workforce development comprising,
a customer relationship management system;
a learning management system;
an e-commerce system;
a volunteer and donation management system;
a generative AI system comprising a knowledge-based large language model trained on federally accredited data, proprietary workforce datasets, and partner insights.
a custom membership card/certificate system;
a workforce placement and career development module;
and an Azure virtual private server hosting infrastructure; wherein the system integrates gamified workforce readiness programming and multi-channel stakeholder engagement.

2. The system of claim 1, wherein the learning management system is structured around a plurality of pillars, wherein each pillar combines gamified modules and activities configured to award points and milestones tied to workforce readiness outcomes, including certifications, internships, and employer-aligned benchmarks.

3. The system of claim 1, wherein users earn points, badges, and incentives based on completion of program activities, wherein said gamified incentives are directly linked to real-world career readiness milestones and workforce pathway progress.

4. The system of claim 1, wherein the generative AI system personalizes learning, provides personalized guidance, mentor-matching signals, curriculum alignment, and predictive workforce analytics.

5. The system of claim 1, further comprising a dual architecture including:
a. Software-as-a-Service (SaaS) module for learners configured to deliver assessments, guided pathways, mentorship, and gamified career progression; and
b. Workforce-as-a-Service (WaaS™) module for employers, educators, and partners configured to deliver job and internship boards, workforce analytics, and pipeline management; wherein data flows bidirectionally between the SaaS and WaaS™ modules.

6. The system of claim 1, wherein the system fosters community engagement through interactive communication tools, role-specific dashboards, and mentor-mentee collaboration features accessible to learners, mentors, educators, and employers.

7. The system of claim 1, wherein the workforce placement module includes integration with employer and partner systems to support job placement and career pipeline development, including predictive matching of learners to employer needs using AI-driven workforce analytics.

8. The system of claim 1, wherein the gamification system incorporates interactive activities, leaderboards, and achievement milestones, wherein GT3S AI adapts challenges and milestone progression based on learner performance and workforce readiness signals.

9. The system of claim 1, wherein data captured from user interactions is processed to generate performance insights, multi-stakeholder dashboards that provide learners with progress reports, mentors with mentee readiness insights, educators with curriculum alignment cues, and employers with predictive pipeline analytics.

10. A method of delivering workforce readiness and pipeline development comprising:
providing learners with access to a gamified SaaS module delivering assessments, skills training, mentor matching, and career pathways;
providing employers, educators, and partners with access to a WaaS™ module delivering dashboards, pipeline analytics, and job postings;
integrating a modular AI assistant configured as a knowledge-based LLM trained on accredited and proprietary data sources;
linking gamified milestones to real-world workforce readiness outcomes;
and generating predictive analytics for workforce pipeline management across multi-stakeholder dashboards.
